(19) United States
(12) Patent Application Publication
(10) Pub. No.: US 2014/0025823 A1
(43) Pub. Date: Jan. 23, 2014

(54) METHODS FOR MANAGING CONTENDED RESOURCE UTILIZATION IN A MULTIPROCESSOR ARCHITECTURE AND DEVICES THEREOF

(71) Applicant: F5 Networks, Inc., Seattle, WA (US)

(72) Inventors: Paul I. Szabo, Shoreline, WA (US); William R. Baumann, Seattle, WA (US)

(73) Assignee: F5 NETWORKS, INC., Seattle, WA (US)

(21) Appl. No.: 13/731,550

(22) Filed: Dec. 31, 2012

Related U.S. Application Data
(60) Provisional application No. 61/600,916, filed on Feb. 20, 2012.

(51) Int. Cl. H04L 12/26

(52) U.S. Cl. CPC H04L 43/16
USPC 709/226

(57) ABSTRACT

A method, computer readable medium, and network traffic management apparatus that manages contended resource utilization includes obtaining at least one value for at least one utilization parameter for at least one contended resource and determining when the obtained value of the utilization parameter for the at least one contended resource exceeds a threshold value. When the obtained value of the utilization parameter is determined to exceed the threshold value, a work rate for one or more of a plurality of processing units is reduced or the at least one contended resource is reallocated among the plurality of processing units.

### CROSS-REFERENCE TO RELATED APPLICATIONS

This application claims the benefit of U.S. Provisional Patent Application Ser. No. 61/600,916, filed Feb. 20, 2012, which is hereby incorporated by reference in its entirety.

### FIELD

This technology generally relates to managing utilization of one or more contended resources in a multiprocessor architecture, and, more particularly, to methods and devices for balancing resource utilization in a network traffic management apparatus configured to manage transmission control protocol (TCP) packets, for example, originating from client computing devices and TCP packets, for example, originating from server devices, to thereby improve network round trip and response time.

### BACKGROUND

Multiprocessor architectures allow the simultaneous use of multiple processing units in order to increase the overall performance of a computing device. With a multiprocessor architecture, processes and threads can run simultaneously on different processing units instead of merely appearing to run simultaneously as in single processor architectures utilizing multitasking and context switching. Parallel processing is further advantageously leveraged in multiprocessor architectures including a dedicated memory, and optionally a dedicated network interface controller, for each processing unit in order to avoid the overhead required to maintain a shared memory, including the locking and unlocking of portions of the shared memory. Additionally, many other resources can be shared by the processing units.

One such computing device benefiting from a multiprocessor architecture is a network traffic management apparatus which can run a traffic management microkernel (TMM) instance on each processing unit, for example. The TMMs are configured to manage network traffic (e.g. TCP packets) and perform other functions such as load balancing network traffic across a plurality of server devices, compression, encryption, and packet filtering, for example. Accordingly, by operating a TMM instance on each processing unit of a multiprocessor architecture, the traffic management process can be parallelized. In order to distribute traffic to the processing units of the microprocessor architecture, to be handled by the associated TMM, one or more distributors, such as one or more switches or one or more disaggregators, can be provided between the processing units and the client computing devices originating the request traffic and/or the server devices originating the response traffic. Accordingly, the distributor(s) are effectively a hardware-based load balancer configured to distribute traffic flows across the processing units and associated TMM instances.

The distributors(s) are generally not intelligent and distribute packets according to the output of a simple formula or a round-robin policy in order to reduce balancing overhead. However, over time one or more processing units tends to be unbalanced in terms of load and/or number of open connections due to one or more TCP packets having a longer round trip time between the network traffic management apparatus and the server device(s), for example. Accordingly, a subset of the processing units in the multiprocessor architecture tend to have a relatively longer work completion rate which tends to increase over time, due to decreasing cache utilization, among other factors. The decreased work completion rate can cause the subset of processing units to fall further behind as compared to the other processing units as the arrival rate for each processing unit remains substantially the same.

Accordingly, empirical analysis has indicated that in a four processing unit multiprocessor architecture, for example, when network congestion is relatively high, one processing unit tends to be fully utilized while each of the other three processing units tend to be utilized at a stable, lower percentage around 70%-90%, for example. While the increasing retransmission rate of the fully utilized processing unit may result in a reduced arrival rate for all processing units, the other processing units will likely remain underutilized, and the fully utilized processing unit will likely remain underperforming, due to the unbalanced load, which is not desirable.

### SUMMARY

A method for managing contended resource utilization includes obtaining by a network traffic management apparatus at least one value for at least one utilization parameter for at least one contended resource. The network traffic management apparatus determines when the obtained value of the utilization parameter for the at least one contended resource exceeds a threshold value. When the obtained value of the utilization parameter is determined by the network traffic management apparatus to exceed the threshold value, a work rate for one or more of a plurality of processing units is reduced by the network traffic management apparatus, or the at least one contended resource is reallocated, by the network traffic management apparatus, among the plurality of processing units.

A non-transitory computer readable medium having stored thereon instructions for managing contended resource utilization in a network traffic management apparatus comprising machine executable code which when executed by at least one processing unit of a plurality of processing units, causes the processing unit to perform steps including obtaining at least one value for at least one utilization parameter for at least one contended resource and determining when the obtained value of the utilization parameter for the at least one contended resource exceeds a threshold value. When the obtained value of the utilization parameter is determined to exceed the threshold value, a work rate for one or more of a plurality of processing units is reduced or the at least one contended resource is reallocated among the plurality of processing units.

A network traffic management apparatus includes a plurality of processing units and a memory unit coupled to one or more of the plurality of processing units which are configured to execute programmed instructions stored in the memory unit including obtaining at least one value for at least one utilization parameter for at least one contended resource and determining when the obtained value of the utilization parameter for the at least one contended resource exceeds a threshold value. When the obtained value of the utilization parameter is determined to exceed the threshold value, a work rate for one or more of a plurality of processing units is reduced or the at least one contended resource is reallocated among the plurality of processing units.

This technology provides a number of advantages including methods, non-transitory computer readable medium, and devices that more effectively manage utilization of one or more contended resources in a multiprocessor architecture. With this technology, a utilization parameter value is obtained for one or more contended resources. When the utilization parameter value exceeds a threshold value, a work rate is reduced for a subset of the plurality of processing units. In some examples, the work rate is reduced in response to implementation of a random early delay and/or random early drop policy. As a result, utilization of the contended resource is improved based on an improved aggregate utilization of the resource and/or improved balance or predictability with respect to utilization of the resource. Additionally, network traffic round trip and/or response time can be reduced.

### BRIEF DESCRIPTION OF THE DRAWINGS

FIG. 1 is a block diagram of a network environment which incorporates an exemplary network traffic management apparatus; and

FIG. 2 is a flowchart of an exemplary method for managing utilization of one or more contended resources using the exemplary network traffic management apparatus of FIG. 1.

### DETAILED DESCRIPTION

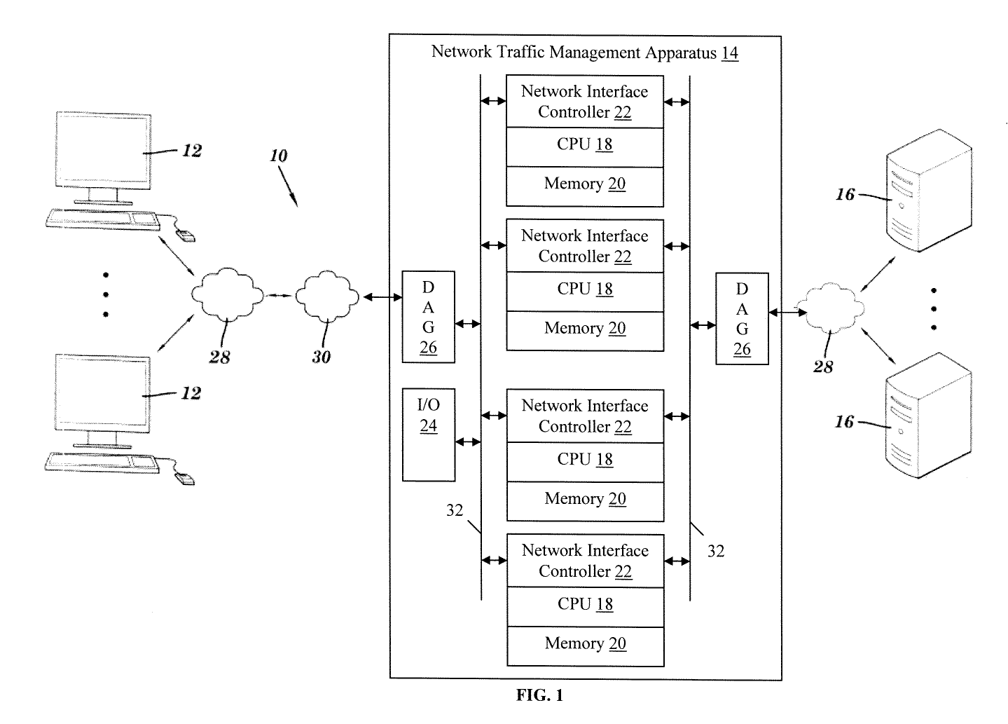

An exemplary network environment 10 is illustrated in FIG. 1 as including client computing devices 12, network traffic management apparatus 14 in an asymmetric deployment, though network traffic management apparatus 14 may be in an alternate asymmetric deployment and/or multiple network traffic management apparatus 14 may be in a symmetric deployment, and server devices 16 which are coupled together by local area networks (LAN) 28 and wide area network (WAN) 30, although other types and numbers of devices and components in other topologies could be used. While not shown, the environment 10 may include additional network components, such as routers, switches and other devices.

More specifically, network traffic management apparatus 14 is coupled to client computing devices 12 through one of the LANs 28, although the client computing devices 12 or other devices and network traffic management apparatus 14 may be coupled together via other topologies. Additionally, the network traffic management apparatus 14 is coupled to the server devices 16 through another one of the LANs 28, although the server devices 16 or other devices and network traffic management apparatus 14 may be coupled together via other topologies. LANs 28 each may employ any suitable interface mechanisms and communications technologies including, for example, telecommunications in any suitable form (e.g., voice, modem, and the like), Public Switched Telephone Network (PSTNs), Ethernet-based Packet Data Networks (PDNs), combinations thereof, and the like.

The network traffic management apparatus 14 is also coupled to client computing devices 12 through the WAN 30, which may comprise any wide area network (e.g., Internet), although any other type of communication network topology may be used, and one of the LANs 28. Various network processing applications, such as CIFS applications, NFS applications, HTTP Web Server applications, FTP applications, may be operating on the server devices 16 and transmitting data (e.g., files, Web pages) through the network traffic management apparatus 14 in response to requests for content from client computing devices 12.

In this example, the network traffic management apparatus 14 may run one or more communication management applications, including a traffic management microkernel (TMM) instance, on each of a plurality of processing units 18 to manage network communications by optimizing, securing, encrypting, filtering, and/or accelerating the network traffic between client computing devices 12 and server devices 16, and/or one or more applications to manage the manipulation, compression, and/or caching of content, application acceleration, load balancing, rate shaping, and SSL offloading, although network traffic management apparatus 14 may perform other network related functions. Moreover, network communications may be received and transmitted by the network traffic management apparatus 14 from and to one or more of the LANs 28 and WAN 30 in the form of network data packets in the TCP/IP protocol, although the network data packets could be in other network protocols.

The network traffic management apparatus 14 includes processing units 18 and memory units 20 and network interface controllers (NICs) 22, each coupled to one of the processing units 18, one or more interfaces 24, and one or more distributors 26, which are coupled together by at least one bus 32, although the network traffic management apparatus 14 may comprise other types and numbers of resources in other configurations including at least one high speed bridge, an embedded packet velocity acceleration (ePVA) module, a cryptographic module configured to encrypt an decrypt some or all of the network traffic, a compression module, additional buses, switch fabric, or any other contended computation device, for example. Some or all of these resources may be contended with respect to utilization by a plurality of the processing units 18 or other elements or resources of the network traffic management apparatus 14. Additionally, one or more of the memory 20 or network interface controllers 22 can be shared by one or more of the processing units 18. Although the exemplary network traffic management apparatus 14 is shown in FIG. 1 as being a standalone device, such as a BIG-IP® device offered by F5 Networks, Inc., of Seattle, Wash., it should be appreciated that the network traffic management apparatus 14 could also be one of several blades coupled to a chassis device, such as a VIPRION® device, also offered by F5 Networks, Inc., of Seattle, Wash.

The processing units 18 can be one or more central processing units, configurable hardware logic devices including one or more field programmable gate arrays (FPGAs), field programmable logic devices (FPLDs), application specific integrated circuits (ASICs) and/or programmable logic units (PLUs), network processing units, and/or processing cores configured to execute the traffic management applications that operate on the network communications between applications on the client computing devices 12 and server devices 16, as well as one or more computer-executable instructions stored in the memory units 20 and other operations illustrated and described herein. Additionally, one or more of the contended resources can include one or more of the processing units 18. One or more of the processing units 18 may be AMD® processors, although other types of processors could be used (e.g., Intel®).

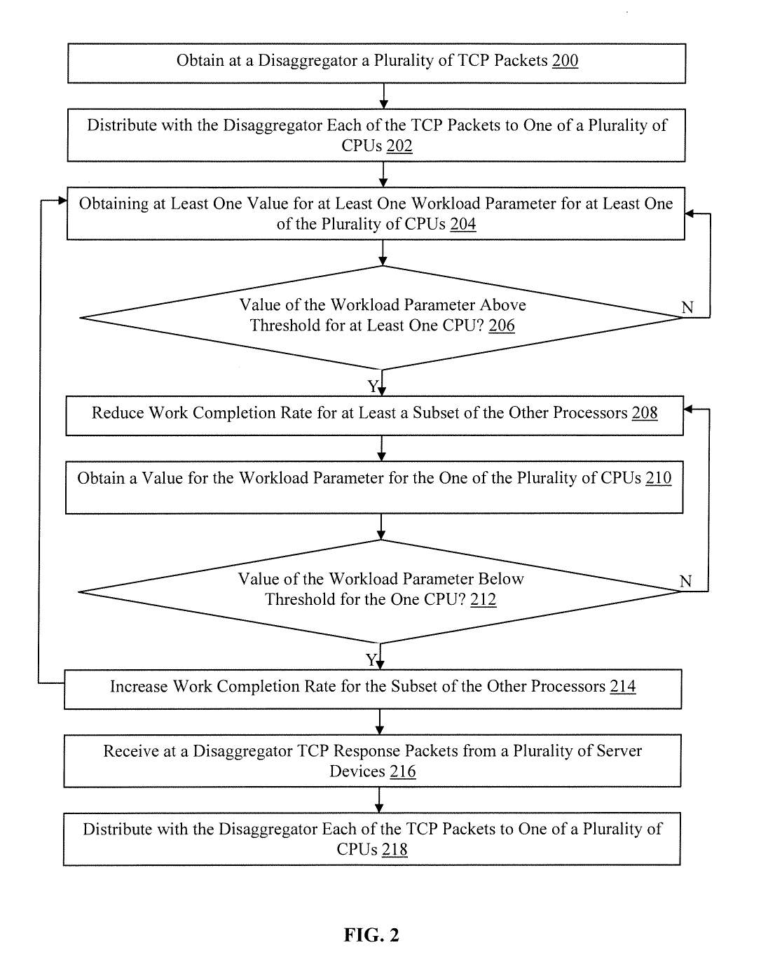

The memory units 20 may comprise one or more tangible storage media such as, for example, RAM, ROM, flash memory, solid state memory, or any other memory storage type or devices, including combinations thereof, which are known to those of ordinary skill in the art. The memory units 20 may store one or more computer-readable instructions that may be executed by one of the processing units 18, contended resources, and/or NICs 22. When these stored instructions are executed, they may implement processes that are illustrated, for exemplary purposes only, by the flow chart diagram shown in FIG. 2.

NICs 22 may comprise specialized hardware to achieve maximum execution speeds, such as FPGAs, although other hardware and/or software may be used, such as ASICs, FPLDs, PLUs, software executed by the processing units 18, and combinations thereof. The use of the specialized hardware in this example, however allows the NICs 22 and/or the processing units 18 executing programmed instructions stored in the memory units 20 to efficiently assist with the transmission and receipt of data packets, such as TCP request and/or response packets, via WAN 30 and the LANs 28 and implement network traffic management techniques. It is to be understood that NICs 22 may take the form of a network peripheral card or other logic that is installed inside a bus interface within the network traffic management apparatus 14 or may be an embedded component as part of a computer processor motherboard, a router or printer interface, or a USB device that may be internal or external to the network traffic management apparatus 14.

Input/output interface 24 includes one or more keyboard/mouse interfaces, display devices interfaces, and other physical and/or logical mechanisms for enabling network traffic management apparatus 14 to communicate with the outside environment, which includes WAN 30, LANs 28 and users (e.g., administrators) desiring to interact with network traffic management apparatus 14, such as to configure, program or operate it. The bus 32 is a hyper-transport bus in this example, although other bus types may be used, such as PCI.

The distributors 26 in this example are hardware-based load balancers for distributing network traffic flows to the processing units 18, and particularly the TMM instances operating on each of the processing units 18, such as one or more switches or disaggregators (DAGs), although the distributors 26 can be implemented in software or any combination of hardware and software.

Each of the client computing devices 12 and server devices 16 include a central processing unit (CPU) or processor, a memory, and an interface or I/O system, which are coupled together by a bus or other link, although other numbers and types of network devices could be used. The client computing devices 12, in this example, may run interface applications, such as Web browsers, that may provide an interface to make requests for and send content and/or data to different server based applications via the LANs 28 and WAN 30. Generally, server devices 16 process requests received from requesting client computing devices 12 via LANs 28 and WAN 30 according to the HTTP-based application RFC protocol or the CIFS or NFS protocol in this example, but the principles discussed herein are not limited to this example and can include other application protocols. A series of applications may run on the server devices 16 that allow the transmission of data, such as a data file or metadata, requested by the client computing devices 12. The server devices 16 may provide data or receive data in response to requests directed toward the respective applications on the server devices 16 from the client computing devices 12.

As per TCP, request packets may be sent to the server devices 16 from the requesting client computing devices 12 to send data and the server devices 16 may send response packets to the requesting client computing devices 12. It is to be understood that the server devices 16 may be hardware or software or may represent a system with multiple server devices 16, which may include internal or external networks. In this example the server devices 16 may be any version of Microsoft® IIS servers or Apache® servers, although other types of servers may be used. Further, additional server devices 16 may be coupled to the LAN 28 and many different types of applications may be available on server devices 16 coupled to the LAN 28.

Although an exemplary network environment 10 with client computing devices 12, network traffic management apparatus 14, server devices 16, LANs 28 and WAN 30 are described and illustrated herein, other types and numbers of systems, devices, blades, components, and elements in other topologies can be used. It is to be understood that the systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those ordinary skill in the art.

In addition, two or more computing systems or devices can be substituted for any one of the systems in any example. Accordingly, principles and advantages of distributed processing, such as redundancy and replication also can be implemented, as desired, to increase the robustness and performance of the devices and systems of the examples. The examples may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The examples may also be embodied as a computer readable medium having instructions stored thereon for one or more aspects of the technology as described and illustrated by way of the examples herein, which when executed by one or more of the processing units 18, cause the processing units 18 to carry out the steps necessary to implement the methods of the examples, as described and illustrated herein.

An exemplary method for managing contended resource utilization in a network traffic management apparatus 14 including a multiprocessor architecture will now be described with reference to FIGS. 1-2. In this particular example, one of the processing units 18 is used as the contended resource, however, the contended resource can be one or more of a high speed bridge, a bus, switch fabric, an embedded packet velocity acceleration (ePVA) module, a cryptographic module, a compression module, or any other contended computation device, for example, or any other resource of the network traffic management apparatus 14. Accordingly, in this example, the client computing devices 12 initiate transmission of a plurality of TCP packets over LAN 28 and WAN 30 which are obtained, at step 200, by the distributor 26 of the network traffic management apparatus 14. While examples of the invention are described herein with respect to TCP network packets, the network traffic can be based on any network protocol.

At step 202, the distributor26 distributes each of the TCP packets to one of the plurality of processing units 18. The work acceptance rate of the TCP packets is therefore substantially the same for each of the processing units 18 due to the proximity of the distributor26 between a sender of the TCP packets and the processing units 18. In this example, a TMM instance operating on each processing unit 18 manages the TCP packets, such as by balancing the distribution of the TCP packets to the server devices 16 and/or performing encryption, compression, and/or packet filtering, for example.

In parallel with obtaining, at the distributor 26, a plurality of TCP packets at step 200, and distributing, with the distributor 26, each of the TCP packets to one of a plurality of processing units 18, at step 204 at least one processing unit 18 communicates with one or more of the other processing units 18 to obtain a value for at least one utilization parameter. Optionally, the at least one processing unit 18 communicates with the one or more other processing units based on a specific time or processing unit 18 cycle interval. Also optionally, each of the processing units 18 communicate with each of the other processing units 18 to obtain the associated utilization parameter.

Accordingly, steps 200 and 202 can occur independently of, and in parallel to, any of the other steps shown in FIG. 2, as described an illustrated below. In this example, the utilization parameter can be the utilization parameter can be processing unit 18 utilization, transmission control protocol (TCP) queue utilization, a number of TCP flows currently managed, or a number of TCP flows currently retransmitting one or more TCP packets, although any parameter(s) indicating utilization, software or hardware queue depths, fullness of hardware FIFO queues, and/or hardware or software data loss due to over-capacity, can be used. In other examples, the utilization parameter can be any utilization characteristic of the contended resource such as high speed bridge or ePVA module table allocation usage by one or more of the processing units, for example.

In one example in which a TCP queue utilization parameter is used, each memory unit 20 is configured to maintain a queue of TCP packets including those packets it cannot currently process due to a policy or full processing unit 18 utilization, for example. In another example in which a number of TCP flows is used, each memory unit 20 is configured to maintain a count of each TCP flow or connection currently established with the processing unit 18 coupled to the memory 20. In yet another example in which a number of TCP flows currently retransmitting one or more TCP packets parameter is used, each memory unit 20 is configured to maintain a count of each TCP flow or connection currently established with the processing unit 18 coupled to the memory 20 for which one or more TCP packets has been dropped and/or retransmitted.

At step 206, at least one processing unit 18, and in this example each processing unit 18, determines whether the value of the one or more utilization parameters, obtained at step 204, exceeds a threshold value for at least one other processing units 18. The threshold values for the parameter(s) can be stored in each of the memory units 20 and/or can be established by a manufacturer or input by an administrator of the network traffic management apparatus 14 using the input/output interface 24, for example. The threshold values in this example correspond to a processing unit 18 utilization level that is less than full utilization. If none of the values of the utilization parameter(s) exceed the threshold value for any of the other processing units 18, each processing unit 18 takes no action. In this exemplary operation, the network traffic management apparatus 14 continues to receive TCP packets, at step 200, and to distribute the TCP packets according to the policy of the distributor26, at step 202, as well as to asynchronously obtain utilization parameter values at step 204 according to an established time interval, for example.

Because the distributor26 generally applies a round-robin distribution policy, or another relatively predictable policy, and because some TCP communications from a processing unit 18 to a server device 16 and/or from a server device 16 to a processing unit 18 take longer than other communications, based on the size of the communications and/or the location of the data required for the TCP response, for example, over time, at least one processing unit 18 is likely to become relatively highly utilized as compared to the other processing units 18.

In one example of a four processing unit 18 multiprocessor architecture, as illustrated in FIG. 1, one processing unit 18 handles at least one TCP communication to a server device 16 that requires a relatively long period of time to service and for the processing unit 18 to complete. While the TCP communication is being serviced, the distributor26 may distribute another TCP packet to the processing unit 18, at step 202, and as this occurs over time, the processing unit 18 may begin to drop packets, which are retransmitted, thereby continuing to increase its utilization rate while decreasing its work completion rate because packets are increasingly being dropped and cache utilization is decreasing. The work completion rate can be the average time required to process or service one or more TCP communications such as request or response packet(s), considering retransmissions due to dropped packets, or any other indicator of network traffic processing capacity of a processing unit 18. Accordingly, in this example, one processing unit 18 is likely to become fully utilized while the other processing units 18 may each maintain an approximately seventy percent utilization, for example.

As one of the processing units 18 reaches full utilization, and drops an increasing number of packets, the work acceptance rate will likely automatically decrease based on a congestion avoidance policy, such as an additive-increase-multiplicative-decrease (AIMD) algorithm, implemented by one or more of the client computing devices 12 that originated the TCP packets or a network device disposed between the client computing devices 12 and the network traffic management apparatus 14, such as a router or an intelligent switch, for example. However, because of the balanced utilization of the other processing units 18, and resulting relatively minimal retransmission of TCP packets from those processing units 18, it is unlikely the fully utilized processing unit 18 will be able to reduce its utilization beyond full utilization in response to such a reduced work acceptance rate. Therefore, the fully utilized processing unit 18 is likely to continue to increasingly drop packets and the work completion rate for the processing unit 18 is likely to continue to decrease. Additionally, the other processing units 18 are likely to remain relatively underutilized, requiring an increase in the work acceptance rate, not likely to occur due to the retransmission of the fully utilized processing unit 18 and associated automatic work acceptance rate reduction, in order to increase utilization.

Accordingly, the utilization of the plurality of processing units 18 is likely to arrive, over time, at an unbalanced state and, in the aggregate, an underutilized state, which is not desirable. Accordingly, the value of one or more of the utilization parameters for at least one of the processing units 18 is likely to eventually exceed an established threshold value. When the value of a utilization parameter is above a threshold value for at least one processing unit 18, as determined by the other processing units 18 at step 206, each of the other processing units 18 reduces at least one of its work rates, at step 208.

The work rate can be a work acceptance rate associated with ingress traffic to the processing unit 18 or other contended resource, a work performance rate associated with traffic currently being processed by the processing unit 18 or other contended resource, or a work completion rate associated with egress traffic from the processing unit 18 or other contended resource. The work rate can be reduced by implementing a random early drop policy or implementing a random early delay policy, for example, as set forth in programmed instructions stored in each of the memory units 20 coupled to each of the processing units 18, although other policies for reducing the work rate each of the other processing units 18 can be used.

Accordingly, each of the less utilized processing units 18 can randomly drop TCP packets originated by the client computing devices 12, causing the TCP packets to be retransmitted, or delay communication of TCP packets to the server devices 16 or to the client computing devices 12, such as by utilizing a buffer stored in memory 20 or by allowing processing unit 18 cycles to elapse without performing work, for example. The originating client computing devices 12, or intermediary network devices, will then interpret the delays or drops and automatically reduce the arrival rate of the packets, and associated work acceptance rate of the processing units 18, based on a congestion avoidance policy implemented therein.

As well as resulting in a more substantial reduction in the work acceptance rate as compared to the operational state in which only a fully utilized processing unit 18 is dropping TCP packets, each processing unit 18 will also fall behind, in terms of work completion rate, at a similar rate as compared to the overutilized processing unit 18.

In another example, in place of or in addition to reducing a work rate for one of the contended resources, the network traffic management apparatus 14 can be configured to reallocate the contended resource among the plurality of processing units or other resources, when the obtained value of the utilization parameter is determined to exceed the threshold value. In one example the network traffic management apparatus 14 includes an ePVA module, The ePVA module can be implemented as configurable hardware logic, such as a field programmable gate array, for example, and can be configured to accelerate traffic associated with one or more TCP flows. In this example, the ePVA module can allocate a portion of an associated table to each of the plurality of processing units 18. The table stores information regarding the various connections managed by the processing units 18, for example. Accordingly, if the network traffic management apparatus 14 determines a utilization parameter is above a threshold, such as when one of the processing units 18 has used a threshold portion of its allocated table space, the ePVA can reallocate table space to provide the one processing unit 18 with an additional allocation. With the reallocation, utilization levels of the processing units 18, and associated latency and throughput, can remain relatively balanced without a reduction in work rate. Optionally, in this example, the ePVA can reallocate table space when the portion used by the one processing unit 18 falls below the threshold level.

In an example in which the work rate is reduced, the work rate can be reduced for each processing unit 18 other than the overutilized processing unit 18 in an amount proportional to the respective utilization parameter value for each of the other processing units 18. In this example, the random early drop or random early delay policy requires dropping a certain amount of TCP packets or delaying TCP packets by a certain amount of time wherein the amounts are calculated based on the ratio of the utilization parameter values for each of the other processing units 18. While any of the utilization parameter(s) identified above can be used in step 206, any same or different utilization parameters(s) can be used to determine the ratio and associated amount of packets to be dropped or delayed at step 208.

Accordingly, in one example, at step 206, the value of the utilization parameter for one processing unit 18 is determined by the other processing units 18 to be 95%, thereby exceeding a predetermined threshold value of 90%. In this example, the overutilized processing unit 18 is handling 300 TCP flows while the other three processing units 18 are handling 200 TCP flows, 150 TCP flows, and 100 TCP flows, respectively. Assuming no other processing unit 18 has a higher utilization parameter value, each of the other processing units 18 reduces its work completion rate by dropping a number of packets proportional to a respective utilization parameter value, such as the number of managed TCP flows. Accordingly, the processing unit 18 managing the least number of TCP flows (100), in this example, will drop the largest number of packets As the work rate is reduced, at step 208, for the lesser utilized processing units 18, the arrival rate of TCP packets will automatically decrease, based on the congestion avoidance policy by the sender of the TCP packets, and the overutilized processing unit 18 will decreasingly drop TCP packets as it will have more time between arriving TCP packets to complete TCP packets associated with flows it is currently handling.

In step 210, at least each of the other processing units 18 obtains a value for the utilization parameter utilized in step 204 for at least the one of the plurality of processing units 18 previously determined to be overutilized in step 206. In step 212, each of the other processing units 18 determines whether the value of the utilization parameter for the overutilized processing unit 18 has fallen below the threshold value.

If each of the other processing units 18 determines the value of the utilization parameter has not fallen below the threshold value for the overutilized processing unit 18, the No branch is taken to step 208. In step 208, the work rate is reduced for each of the processing units 18 as described earlier. Thereby, the work completion rate for the lesser utilized processing units 18 continues to be reduced until the utilization parameter value for the overutilized processing unit 18 falls below the threshold value.

If each of the other processing units 18 determines the value of the utilization parameter has fallen below the threshold value for the overutilized processing unit 18, the Yes branch is taken to step 214. In step 214, each of the other processing units 18 increases its respective work rate, such as by reversing the random early drop or random early delay policy implemented in step 208, for example.

Accordingly, in this example, the lesser utilized processing units 18 can continue to drop or delay TCP packets at least until the utilization parameter value of the overutilized processing unit 18 falls below the threshold value. Thereby, the utilization of all of the processing units 18 converges and becomes relatively balanced.

As the utilization of the processing units 18 rebalances, and the work completion rate is no longer purposely reduced, the arrival rate of TCP packets will automatically increase, or at least the predictability of the arrival rate will increase, according to the congestion avoidance policy of the sender of the TCP packets, and the utilization levels of all of the processing units 18 will increase as well as the aggregate processing unit 18 utilization. Subsequent to the rebalancing of steps 208-212, each of the processing units 18 can again obtain at least one value for at least one utilization parameter for at least one, and optionally all, of the other processing units 18, as described earlier. If one of the processing units 18 is overutilized, steps 206-214 are again performed. While one exemplary feedback loop has been described herein with respect to steps 204-212, other feedback loops can also be utilized.

Accordingly, instead of the system stabilizing at one or more processing units 18 fully utilized and the utilization of the other processing units 18 remaining idle and underutilized, this technology provides for a periodic rebalancing which allows the processing units 18 to spend a greater percentage of time operating at a relatively higher aggregate utilization level and/or at relatively more predictably or in a more balanced fashion.

In parallel with any of the previously-identified steps, at step 216, the distributor26 receives a plurality of TCP packets from a plurality of server devices 16 optionally in response to the TCP packets obtains in step 200. At step 218, the distributor26 distributes each of the TCP packets to one of the processing units 18 which may be configured to communicate the TCP packets originating from the one or more of the server devices 16 to one or more of the client computing devices 12. Accordingly, steps 216 and 218 can occur independently of, and in parallel to, any of the other steps shown in FIG. 2, as described an illustrated earlier.

As described herein, this technology provides improved contended resource utilization in a multiprocessor architecture. In one example, the contended resource is a processing unit and a work rate of one or more other processing units is purposely reduced, such as by implementing a random early delay and/or a random early drop policy, in order to rebalance the utilization levels among the processing units. In other examples, the network traffic management apparatus 14 is configured to reallocate, by the network traffic management apparatus, the at least one contended resource among the plurality of processing units in order to rebalance utilization of the contended resource. As a result, the contended resource will spend a greater percentage of time at an increased aggregate and/or balanced utilization level and the user experience will be improved based on increased throughput and reduced round trip and response time of network communications, for example.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for managing contended resource utilization, comprising:
obtaining, by a network traffic management apparatus, at least one value for at least one utilization parameter for at least one contended resource;
determining, by the network traffic management apparatus, when the obtained value of the utilization parameter for the at least one contended resource exceeds a threshold value; and
reducing, by the network traffic management apparatus, a work rate for one or more of a plurality of processing units, or reallocating, by the network traffic management apparatus, the at least one contended resource among the plurality of processing units, when the obtained value of the utilization parameter is determined to exceed the threshold value.

2. The method as set forth in claim 1 wherein:
the at least one contended resource is one of the processing units;
the obtaining further comprises obtaining at least one value for at least one utilization parameter for each of the plurality of processing units;
the determining further comprises determining when the obtained value of the utilization parameter for any of the plurality of processing units exceeds a threshold value; and
the utilization parameter is selected from at least one of processing unit utilization, transmission control protocol (TCP) queue utilization, a number of TCP flows currently managed, or a number of TCP flows currently retransmitting one or more TCP packets.

3. The method as set forth in claim 1 wherein the at least one contended resource is a high speed bridge, a bus, switch fabric, an embedded packet velocity acceleration (ePVA) module, a cryptographic module, a compression module, or a contended computation device.

4. The method as set forth in claim 1 wherein the work rate is selected from at least one of a work acceptance rate associated with ingress traffic to the at least one contended resource, a work performance rate associated with traffic currently being processed by the at least one contended resource, or a work completion rate associated with egress traffic from the at least one contended resource.

5. The method as set forth in claim 1 wherein the reducing the work rate further comprises at least one of implementing a random early drop policy or implementing a random early delay policy.

6. The method as set forth in claim 2 wherein the work rate is reduced for each of the other processing units by an amount proportional to the respective value of one or more of the utilization parameters for each of the other processing units of the plurality of processing units.

7. A non-transitory computer readable medium having stored thereon instructions for managing contended resource utilization comprising machine executable code which when executed by at least one processing unit of a plurality of processing units, causes the processing unit to perform steps comprising:
obtaining at least one value for at least one utilization parameter for at least one contended resource;
determining when the obtained value of the utilization parameter for the at least one contended resource exceeds a threshold value; and
reducing a work rate for one or more of a plurality of processing units, or reallocating the at least one contended resource among the plurality of processing units, when the obtained value of the utilization parameter is determined to exceed the threshold value.

8. The medium as set forth in claim 7 wherein:
the at least one contended resource is one of the processing units;
the obtaining further comprises obtaining at least one value for at least one utilization parameter for each of the plurality of processing units;
the determining further comprises determining when the obtained value of the utilization parameter for any of the plurality of processing units exceeds a threshold value; and
the utilization parameter is selected from at least one of processing unit utilization, transmission control protocol (TCP) queue utilization, a number of TCP flows currently managed, or a number of TCP flows currently retransmitting one or more TCP packets.

9. The medium as set forth in claim 7 wherein the at least one contended resource is a high speed bridge, a bus, switch fabric, an embedded packet velocity acceleration (ePVA) module, a cryptographic module, a compression module, or a contended computation device.

10. The medium as set forth in claim 7 wherein the work rate is selected from at least one of a work acceptance rate associated with ingress traffic to the at least one contended resource, a work performance rate associated with traffic currently being processed by the at least one contended resource, or a work completion rate associated with egress traffic from the at least one contended resource.

11. The medium as set forth in claim 7 wherein the reducing the work rate further comprises at least one of implementing a random early drop policy or implementing a random early delay policy.

12. The medium as set forth in claim 8 wherein the work rate is reduced for each of the other processing units by an amount proportional to the respective value of one or more of the utilization parameters for each of the other processing units of the plurality of processing units.

13. A network traffic management apparatus comprising:
a plurality of processing units; and
a memory unit coupled to one or more of the plurality of processing units which are configured to execute programmed instructions stored in the memory unit comprising:
obtaining at least one value for at least one utilization parameter for at least one contended resource;
determining when the obtained value of the utilization parameter for the at least one contended resource exceeds a threshold value; and
reducing a work rate for one or more of a plurality of processing units, or reallocating the at least one contended resource among the plurality of processing units, when the obtained value of the utilization parameter is determined to exceed the threshold value.

14. The apparatus as set forth in claim 13 wherein:
the at least one contended resource is one of the processing units;
the obtaining further comprises obtaining at least one value for at least one utilization parameter for each of the plurality of processing units;
the determining further comprises determining when the obtained value of the utilization parameter for any of the plurality of processing units exceeds a threshold value; and
the utilization parameter is selected from at least one of processing unit utilization, transmission control protocol (TCP) queue utilization, a number of TCP flows currently managed, or a number of TCP flows currently retransmitting one or more TCP packets.

15. The apparatus as set forth in claim 13 wherein the at least one contended resource is a high speed bridge, a bus, switch fabric, an embedded packet velocity acceleration (ePVA) module, a cryptographic module, a compression module, or a contended computation device.

16. The apparatus as set forth in claim 13 wherein the work rate is selected from at least one of a work acceptance rate associated with ingress traffic to the at least one contended resource, a work performance rate associated with traffic currently being processed by the at least one contended resource, or a work completion rate associated with egress traffic from the at least one contended resource.

17. The apparatus as set forth in claim 13 wherein the reducing the work rate further comprises at least one of implementing a random early drop policy or implementing a random early delay policy.

18. The apparatus as set forth in claim 14 wherein the work rate is reduced for each of the other processing units by an amount proportional to the respective value of one or more of the utilization parameters for each of the other processing units of the plurality of processing units.
